(19) United States
(12) Patent Application Publication
(10) Pub. No.: US 2026/0005242 A1
(43) Pub. Date: Jan. 1, 2026

(54) METAL SULFIDE CONTAINING CONVERSION CATHODE DESIGN, AND SOLID-STATE ELECTROCHEMICAL CELL CONTAINING THEREOF

(71) Applicant: Solid Power Operating, Inc., Louisville, CO (US)

(72) Inventors: Hong WANG, Northglenn, CO (US); Zichao YANG, Broomfield, CO (US); Pu ZHANG, Boulder, CO (US); Brian CLARK, Broomfield, CO (US)

(21) Appl. No.: 19/251,045

(22) Filed: Jun. 26, 2025

Related U.S. Application Data
(60) Provisional application No. 63/664,633, filed on Jun. 26, 2024.

(51) Int. Cl. H01M 4/58; H01M 4/36

(52) U.S. Cl. CPC H01M 4/5815; H01M 4/364

(57) ABSTRACT

Cathode composites include a transition metal sulfide and a molybdenum sulfide material. The composites display more favorable characteristics, such as charge capacity, as compared to known cathode composites.

### CROSS REFERENCE TO RELATED APPLICATION

This application is related to and claims priority under 35 U.S.C. § 119 from U.S. Provisional Application No. 63/664,633 filed Jun. 26, 2024, titled “Metal Sulfide Containing Conversion Cathode Design, and Solid-State Electrochemical Cell Containing Thereof”, the entire contents of which are fully incorporated by reference herein for all purposes.

### STATEMENT REGARDING FEDERAL RIGHTS

This invention was made with government support under grant number DE-AR0001727 awarded by the Advanced Research Projects Agency-Energy. The government has certain rights in the invention.

### TECHNICAL FIELD

The present disclosure is directed toward cathode composites and methods for making the same. Therefore, the disclosure relates to the fields of batteries, including solid-state batteries, electronics, chemistry, and materials science.

### BACKGROUND AND INTRODUCTION

The need for more energy-dense rechargeable batteries has never been greater. One attempt to meet this need has been to use high nickel content cathode active materials, such as Nickel-Manganese-Cobalt materials also known as NMC. As the nickel content of these materials is increased, the amount of energy these cathode materials can store also increases. However, these high nickel content cathode materials are expensive, which drives up the cost of the final battery pack, which can be particularly meaningful in high-capacity battery packs such as those used in electric vehicles.

In batteries that use solid electrolyte materials, known as solid-state batteries, the NMC cathode material may be replaced with a sulfur containing cathode active materials, which can drastically lower the cost of the final battery pack. Though these sulfur containing cathode materials are much less expensive than the NMC materials, utilizing the full capacity of these materials has proven challenging for a number of reasons.

### SUMMARY OF INVENTION

Provided herein are cathode composite compositions for use in an electrochemical cell. The cathode compositions include a molybdenum sulfide material, wherein the molybdenum sulfide material is present in the cathode composite in an amount of about 1% or less by weight of the cathode composite. In some embodiments, the cathode composites include a transition metal sulfide; a molybdenum sulfide material, wherein the molybdenum sulfide material is present in the cathode composite in an amount of about 1% or less by weight of the cathode composite.

Further provided herein are solid-state electrochemical cells that include an anode layer, a separator layer, and a cathode layer, the cathode layer comprising a cathode composite disposed on a current collector, wherein the cathode composite comprises a molybdenum sulfide material, and wherein the molybdenum sulfide material is present in the cathode composite in an amount greater than 0% to less than about 1% by weight of the cathode composite.

### BRIEF DESCRIPTION OF THE DRAWINGS

FIG. 1 shows the cycling data of a solid-state battery made using the cathode composites formed in Comparative Example 1 and Example 1.

### DETAILED DESCRIPTION

Aspects of the present disclosure include using a transition metal sulfide containing cathode composite in a solid-state battery, resulting in the capacity of that cathode composite being meaningfully increased when a molybdenum sulfide material is incorporated in the cathode composite. In some particular aspects, the molybdenum sulfide material is present in the cathode composite in an amount of less than about 1 wt % by weight of the cathode composite.

In various aspects, the solid-state battery may comprise a cathode layer containing a cathode composite, in the form discussed herein, a separator layer, an anode layer containing an anode active material. In various arrangements the battery may also include a cathode current collector and an anode current collector. Collectively, the various layers may form a discrete electrochemical cell. In some arrangements, the battery may have stacks of such cells in various possible arrangements where current collectors are shared or not, anodes or cathodes are back-to-back or not, and the like.

### Cathode Composite

The cathode composite may include a transition metal sulfide, molybdenum sulfide material, a conductive additive, a solid electrolyte material, a binder, or any combination thereof. For example, the cathode composite may include a transition metal sulfide and a molybdenum sulfide material, optionally a conductive additive, optionally a solid electrolyte material, and optionally a binder.

The transition metal sulfide may include a transition metal sulfide or a lithiated transition metal sulfide. The transition metal may include iron, titanium, copper, cobalt, tungsten, or other transition metals or combinations thereof. For example, the transition metal sulfide may include FeS, FeS₂, LiFeS₂, Li₂FeS₂, Li₃FeS₂, TiS₂, LiTiS₂, Li_{1.5}TiS₂, Li₂TiS₃, or any combination thereof.

The transition metal sulfide may be present in the cathode composite in an amount from about 1% to about 90% by weight of the cathode composite. In various embodiments, the transition metal sulfide may be present in the cathode composite in an amount from about 1% to about 90% by weight, about 5% to about 80% by weight, about 10% to about 70% by weight, or about 20% to about 60% by weight of the cathode composite. In some embodiments, the transition metal sulfide may be present in the cathode composite in an amount of about 5%, 10%, 15%, 20%, 25%, 30%, 35%, 40%, 45%, 50%, 55%, or 60% by weight of the cathode composite.

The molybdenum sulfide material may include a non-lithiated molybdenum sulfide material or a lithiated molybdenum sulfide material. The non-lithiated molybdenum sulfide material may include MoS_{z}, wherein 2≤z≤3. The lithiated molybdenum sulfide material may include LiₓMoS_{y}, wherein 0<x≤4 and 1≤y≤4. The molybdenum sulfide material may include MoS₂MoS₃, LiMoS₂, Li₂MoS₂, Li₃MoS₂, or any combination thereof.

In some embodiments, the molybdenum sulfide material may include MoS_{z} and LiₓMoS_{y} present in a weight ratio from about 1:99 to about 99:1. For example, the weight ratio of MoS_{z} to LiₓMoS_{y} may be about 1:99 to about 1:90, about 1:99 to about 1:60, about 1:99 to about 1:40, about 1:99 to about 1:20, about 1:99 to about 1:10, about 1:99 to about 1:5, about 1:99 to about 1:2, about 1:99 to about 1:1, about 1:99 to about 2:1, about 1:99 to about 5:1, about 1:99 to about 10:1, about 1:99 to about 20:1, about 1:99 to about 40:1, about 1:99 to about 60:1, about 1:99 to about 80:1, about 1:99 to about 90:1, about 1:99 to about 99:1, about 1:90 to about 99:1, about 1:80 to about 99:1, about 1:60 to about 99:1, about 1:40 to about 99:1, about 1:20 to about 99:1, about 1:10 to about 99:1, about 1:5 to about 99:1, about 1:2 to about 99:1, about 1:1 to about 99:1, about 2:1 to about 99:1, about 5:1 to about 99:1, about 10:1 to about 99:1, about 20:1 to about 99:1, about 40:1 to about 99:1, about 60:1 to about 99:1, about 80:1 to about 99:1, or about 90:1 to about 99:1.

The molybdenum sulfide material may be present in the cathode composite in an amount from about 0.05% to about 1% by weight of the cathode composite. In various embodiments, the molybdenum sulfide material may be present in the cathode composite in an amount from about 0.05% to about 0.99% by weight, about 0.05% to about 0.9% by weight, about 0.05% to about 0.8% by weight, about 0.05% to about 0.7% by weight, about 0.05% to about 0.6% by weight, about 0.05% to about 0.5% by weight, about 0.05% to about 0.4% by weight, about 0.05% to about 0.3% by weight, about 0.05% to about 0.2% by weight, or about 0.05% to about 0.1% by weight. In some embodiments, the molybdenum sulfide material may be present in an amount of about 0.05%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, or about 0.99% by weight of the cathode composite.

The conductive additive may include carbon fiber, graphite, graphene, carbon black, conductive carbon, amorphous carbon, vapor grown carbon fiber (VGCF), activated carbon, carbon nanotubes, or any combination thereof.

The conductive additive may be present in the cathode composite in an amount from about 1% to about 20% by weight of the cathode composite. In various embodiments, the transition metal sulfide may be present in the cathode composite in an amount of about 1% to about 20% by weight, about 1% to about 15% by weight, about 1% to about 12% by weight, or about 1% to about 10% by weight. In some embodiments, the transition metal sulfide may be present in an amount of about 1%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%, 16.0%, 16.5%, 17.0%, 17.5%, 18.0%, 18.5%, 19.0%, 19.5%, or about 20.0% by weight of the cathode composite.

In some embodiments, the average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm. The average particle size (e.g., D50) may be determined through any method known to those having ordinary skill in the art, for example, by a particle size analyzer or a transmission electron microscope photograph or a scanning electron microscope photograph. Alternatively, the size may be measured using a dynamic light scattering method, and data analysis may be performed to count the number of particles with respect to each particle size range, and then calculated to obtain an average particle diameter value. Unless otherwise specified, the average particle diameter may be measured by a particle size analyzer, and refers to a diameter (D50) of particles having a cumulative volume of 50 vol % in a particle size distribution.

The solid electrolyte material may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S S—SiS₂—Li₃PO₄, and Li₂S—S—SiS₂-LiₓMO_{y} (where x and y are positive numbers, and M is P, Si, Ge, B, Al, Ga or In).

The solid electrolyte material may include Li₃PS₄, Li₄P₂S₆, Li₂P₃S₁₁, Li₁₀GeP₂S₁₂, Li₁₀SnP₂S₁₂, or any combination thereof. In a further embodiment, the solid electrolyte may be an argyrodite electrolyte, such as Li₆PS₅Cl, Li₆PS₅Br, Li₆PS₅I, or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN, or any combination thereof. In yet another embodiment, the solid-state electrolyte material may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The solid electrolyte material may include a halide solid electrolyte. Halide solid electrolytes may have the structure Li-M-X, wherein M is a metal element and X is a halogen. These may be expressed by the generic formula Li_{α}M⁴⁺_{β}A³⁺_{(1-β)}X_{Ω}Y_{(6-Ω)}, where: 0≤β≤1; 0≤Ω≤6; α=6−[(β*4)+(1−β)*3]; X and Y are each independently a halogen such as F, Cl, Br, or I; M is an element with an oxidation state of 4⁺ such as Ti, Zr, Hf, or Rf; and A is an element an oxidation state of 3⁺ such as Ga, In, Tl, Sc, Y, Fe, Ru, Os, or Er. Examples of halide solid electrolytes include Li₂ZrCl₆, Li₃InCl₆, and Li_{2.25}Hf_{0.75}Fe_{0.25}Cl₄Br₂.

In general, the solid electrolyte may be present in the cathode composite in an amount from about 0% to about 60% by weight of the cathode composite. In various embodiments, the solid electrolyte may be present in the cathode composite in an from of about 0% to about 10% by weight, about 0% to about 20% by weight, about 0% to about 30% by weight, about 0% to about 40% by weight, about 0% to about 50% by weight, about 10% to about 60% by weight, about 20% to about 60% by weight, about 30% to about 60% by weight, about 40% to about 60% by weight, about 50% to about 60% by weight, about 10% to about 50% by weight, or about 20% to about 40% by weight. In some embodiments, the solid electrolyte material may be present in the cathode composite in an amount of about 5%, 10%, 15%, 20%, 25%, 30%, 35%, 40%, 45%, 50%, 55%, or 60% by weight of the cathode composite.

The solid electrolyte material may have an average particle size from about 0.5 microns to about 50 microns, such as from about 0.5 microns to about 1 micron, about 0.5 microns to about 10 microns, about 0.5 microns to about 20 microns, about 0.5 microns to about 30 microns, about 0.5 microns to about 40 microns, about 0.5 microns to about 0.5 microns, about 1 micron to about 50 microns, about 10 microns to about 50 microns, about 20 microns to about 50 microns, about 30 microns to about 50 microns, or about 40 microns to about 50 microns. As another example, the solid electrolyte material may have an average particle size of about 0.5 microns, 0.6 microns, 0.7 microns, 0.8 microns, 0.9 microns, 1 micron, 2 microns, 3 microns, 4 microns, 5 microns, 6 microns, 7 microns, 8 microns, 9 microns, 10 microns, 15 microns, 20 microns, 25 microns, 30 microns, 35 microns, 40 microns, 45 microns, or about 50 microns.

The binder may comprise one or more thermoplastic elastomer(s). Suitable non-limiting examples of thermoplastic elastomers include styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like. In an embodiment, the binder includes a styrene-ethylene-butylene-styrene block copolymer (SEBS).

Generally, the binder may be present in the cathode composite in an amount from about 1.0% to about 40.0% by weight of the cathode composite. In various embodiments, the binder may be present in the cathode composite in an amount from about 1.0% to about 40.0%, about 1.0% to about 10.0%, about 1.0% to about 15.0%, about 5.0% to about 20.0%, about 10.0% to about 20.0%, about 15.0% to about 20.0%, about 20.0% to about 25.0%, about 20.0% to about 30.0%, about 20.0% to about 35.0%, about 20.0% to about 40%, about 30.0% to about 35.0%, or about 30.0% to about 40.0%. In some embodiments, the binder may be present in the cathode composite in an amount of about 1.0%, 2.0%, 3.0%, 4.0%, 5.0%, 6.0%, 7.0%, 8.0%, 9.0%, 10.0%, 15.0%, 20.0%, 25.0%, 30.0%, 35.0%, or about 40.0% by weight of the cathode composite. In an embodiment, the binder is present in the cathode composite in an amount from about 1.0% to about 5.0% by weight of the cathode composite.

### Anode Layer

The anode layer may include an anode active material, a conductive additive, a solid electrolyte material, a binder, or any combination thereof. In some embodiments, the anode layer may include an anode active material, optionally a conductive additive, optionally a solid electrolyte material, and optionally a binder.

The anode active material in the anode layer may comprise Silicon (Si), Tin (Sn), Germanium (Ge), graphite, Li₄Ti₅O₁₂ (LTO), lithium metal, lithium metal alloy, or other known anode active materials or any combination thereof.

The anode active material may be present in the anode layer in an amount from about 30% to about 100% by weight of the anode layer. In some aspects, the anode active material may be present in the anode layer in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 100%, about 40% to about 100%, about 45% to about 100%, about 50% to about 100%, about 55% to about 100%, about 60% to about 100%, about 65% to about 100%, about 70% to about 100%, about 75% to about 100%, about 80% to about 100%, about 100% to about 100%, about 90% to about 100%, about 40% to about 90%, about 40% to about 80%, about 40% to about 70%, about 40% to about 60%, about 40% to about 55%, about 40% to about 50%, or about 40% to about 45% by weight.

The anode active material may have an average particle size from about 0.5 microns to about 50 microns, such as from about 0.5 microns to about 1 micron, about 0.5 microns to about 10 microns, about 0.5 microns to about 20 microns, about 0.5 microns to about 30 microns, about 0.5 microns to about 40 microns, about 0.5 microns to about 0.5 microns, about 1 micron to about 50 microns, about 10 microns to about 50 microns, about 20 microns to about 50 microns, about 30 microns to about 50 microns, or about 40 microns to about 50 microns. As another example, the anode active material may have an average particle size of about 0.5 microns, 0.6 microns, 0.7 microns, 0.8 microns, 0.9 microns, 1 micron, 2 microns, 3 microns, 4 microns, 5 microns, 6 microns, 7 microns, 8 microns, 9 microns, 10 microns, 15 microns, 20 microns, 25 microns, 30 microns, 35 microns, 40 microns, 45 microns, or about 50 microns.

The conductive additive may include carbon fiber, graphite, graphene, carbon black, conductive carbon, amorphous carbon, vapor grown carbon fiber (VGCF), activated carbon, carbon nanotubes, or any combination thereof.

The conductive additive may be present in the anode layer in an amount of about 1% to about 20% by weight of the anode layer. In various embodiments, the conductive additive may be present in the anode layer in an amount of about 1% to about 20% by weight, about 1% to about 15% by weight, about 1% to about 12% by weight, or about 1% to about 10% by weight. In some embodiments, the conductive additive may be present in an amount of about 1%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%, 16.0%, 16.5%, 17.0%, 17.5%, 18.0%, 18.5%, 19.0%, 19.5%, or about 20.0% by weight of the anode layer.

The average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm.

The solid electrolyte material may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S S—SiS₂—LiCl, Li₂S—S—SiS₂—B₂S₃—LiI, Li₂S—S—SiS₂—P₂S₅—LiI, Li₂S—B₂S₃, Li₂S P₂S₅—ZₘSₙ (where m and n are positive numbers, and Z is Ge, Zn or Ga), Li₂S—GeS₂, Li₂S S—SiS₂—Li₃PO₄, and Li₂S—S—SiS₂-LiₓMO_{y} (where x and y are positive numbers, and M is P, Si, Ge, B, Al, Ga or In).

The solid electrolyte material may include Li₃PS₄, Li₄P₂S₆, Li₂P₃S₁₁, Li₁₀GeP₂S₁₂, Li₁₀SnP₂S₁₂, or any combination thereof. In a further embodiment, the solid electrolyte may be an argyrodite electrolyte, such as Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN, or any combination thereof. In yet another embodiment, the solid-state electrolyte material may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The solid electrolyte material may include a halide solid electrolyte. Halide solid electrolytes may have the structure Li-M-X, wherein M is a metal element, and X is a halogen. These maybe expressed by the generic formula Li_{α}M⁴⁺_{β}A³⁺_{(1-β)}X_{Ω}Y_{(6-Ω)}, where: 0≤β≤1; 0≤Ω≤6; α=6−[(β*4)+(1−β)*3]; X and Y are each independently a halogen such as F, Cl, Br, or I; M is an element with an oxidation state of 4⁺ such as Ti, Zr, Hf, or Rf; and A is an element an oxidation state of 3⁺ such as Ga, In, Tl, Sc, Y, Fe, Ru, Os, or Er. Examples of halide solid electrolytes include Li₂ZrCl₆, Li₃InCl₆, and Li_{2.25}Hf_{0.75}Fe_{0.25}Cl₄Br₂.

In general, the solid electrolyte may be present in the anode layer in an amount from about 0% to about 60% by weight of the anode layer. In various embodiments, the solid electrolyte may be present in the anode layer in an amount from about 0% to about 10% by weight, about 0% to about 20% by weight, about 0% to about 30% by weight, about 0% to about 40% by weight, about 0% to about 50% by weight, about 10% to about 60% by weight, about 20% to about 60% by weight, about 30% to about 60% by weight, about 40% to about 60% by weight, about 50% to about 60% by weight, about 10% to about 50% by weight, or about 20% to about 40% by weight. In some embodiments, the solid electrolyte material may be present in the anode layer in an amount of about 5%, 10%, 15%, 20%, 25%, 30%, 35%, 40%, 45%, 50%, 55%, or 60% by weight of the anode layer.

The solid electrolyte material may have an average particle size from about 0.5 microns to about 50 microns, such as from about 0.5 microns to about 1 micron, about 0.5 microns to about 10 microns, about 0.5 microns to about 20 microns, about 0.5 microns to about 30 microns, about 0.5 microns to about 40 microns, about 0.5 microns to about 0.5 microns, about 1 micron to about 50 microns, about 10 microns to about 50 microns, about 20 microns to about 50 microns, about 30 microns to about 50 microns, or about 40 microns to about 50 microns. As another example, the solid electrolyte material may have an average particle size of about 0.5 microns, 0.6 microns, 0.7 microns, 0.8 microns, 0.9 microns, 1 micron, 2 microns, 3 microns, 4 microns, 5 microns, 6 microns, 7 microns, 8 microns, 9 microns, 10 microns, 15 microns, 20 microns, 25 microns, 30 microns, 35 microns, 40 microns, 45 microns, or about 50 microns.

The binder may comprise one or more thermoplastic elastomer(s). Suitable non-limiting examples of thermoplastic elastomers include styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like. In an embodiment, the binder includes a styrene-ethylene-butylene-styrene block copolymer (SEBS).

Generally, the binder may be present in the anode layer in an amount from about 0% to about 40.0% by weight of the anode layer. In various embodiments, the binder may be present in the anode layer in an amount from about 1.0% to about 40.0%, about 1.0% to about 10.0%, about 1.0% to about 15.0%, about 5.0% to about 20.0%, about 10.0% to about 20.0%, about 15.0% to about 20.0%, about 20.0% to about 25.0%, about 20.0% to about 30.0%, about 20.0% to about 35.0%, about 20.0% to about 40%, about 30.0% to about 35.0%, or about 30.0% to about 40.0%. In some embodiments, the binder may be present in the anode layer in an amount of about 0.0%, 1.0%, 2.0%, 3.0%, 4.0%, 5.0%, 6.0%, 7.0%, 8.0%, 9.0%, 10.0%, 15.0%, 20.0%, 25.0%, 30.0%, 35.0%, or about 40.0% by weight of the anode layer. In an embodiment, the binder is present in the anode layer in an amount from about 1% to about 5% by weight of the anode layer.

### Separator Layer

The separator layer may comprise a solid electrolyte material and a binder.

The solid electrolyte material in the separator may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In).

The solid electrolyte material may include Li₃PS₄, Li₄P₂S₆, Li₂P₃S₁₁, Li₁₀GeP₂S₁₂, Li₁₀SnP₂S₁₂, or any combination thereof. In a further embodiment, the solid electrolyte may be an argyrodite electrolyte, such as Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN, or any combination thereof. In yet another embodiment, the solid-state electrolyte material may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The solid electrolyte material include a halide solid electrolyte. Halide solid electrolytes may have the structure Li-M-X, wherein M is a metal element, and X is a halogen. These may be expressed by the generic formula Li_{α}M⁴⁺_{β}A³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4⁺ such as Ti, Zr, Hf, or Rf; and A is an element an oxidation state of 3⁺ such as Ga, In, Tl, Sc, Y, Fe, Ru, Os, or Er. Examples of halide solid electrolytes include Li₂ZrCl₆, Li₃InCl₆, and Li_{2.25}Hf_{0.75}Fe_{0.25}Cl₄Br₂.

In general, the solid electrolyte may be present in the separator layer in an amount from about 10% to about 99% by weight of the separator layer. In various embodiments, the solid electrolyte may be present in the separator layer in an amount from about 10% to about 95% by weight, about 10% to about 90% by weight, about 10% to about 85% by weight, or about 10% to about 80% by weight, about 10% to about 70% by weight, about 10% to about 60% by weight, about 10% to about 50% by weight, about 10% to about 40% by weight, about 10% to about 30% by weight, about 10% to about 20% by weight, about 20% to about 99% by weight, about 30% to about 99% by weight, about 40% to about 99% by weight, about 50% to about 99% by weight, about 60% to about 99% by weight, about 70% to about 99% by weight, about 80% to about 99% by weight, about 85% to about 99% by weight, about 90% to about 99% by weight, or about 95% to about 99% by weight of the separator layer. In some embodiments, the solid electrolyte material may be present in the separator layer in an amount of about 10%, 20%, 30%, 40%, 50%, 60%, 70%, 80%, 85%, 90%, 95%, or 99% by weight of the separator layer.

The solid electrolyte material may have an average particle size from about 0.5 microns to about 50 microns, such as from about 0.5 microns to about 1 micron, about 0.5 microns to about 10 microns, about 0.5 microns to about 20 microns, about 0.5 microns to about 30 microns, about 0.5 microns to about 40 microns, about 0.5 microns to about 0.5 microns, about 1 micron to about 50 microns, about 10 microns to about 50 microns, about 20 microns to about 50 microns, about 30 microns to about 50 microns, or about 40 microns to about 50 microns. As another example, the solid electrolyte material may have an average particle size of about 0.5 microns, 0.6 microns, 0.7 microns, 0.8 microns, 0.9 microns, 1 micron, 2 microns, 3 microns, 4 microns, 5 microns, 6 microns, 7 microns, 8 microns, 9 microns, 10 microns, 15 microns, 20 microns, 25 microns, 30 microns, 35 microns, 40 microns, 45 microns, or about 50 microns.

The binder in the separator layer may comprise one or more thermoplastic elastomer(s). Suitable non-limiting examples of thermoplastic elastomers include styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like. In an embodiment, the binder includes a styrene-ethylene-butylene-styrene block copolymer (SEBS).

Generally, the binder may be present in the separator layer in an amount from about 1.0% to about 40.0% by weight of the separator layer. In various embodiments, the binder may be present in the separator layer in an amount from about 1.0% to about 40.0%, about 1.0% to about 10.0%, about 1.0% to about 15.0%, about 5.0% to about 20.0%, about 10.0% to about 20.0%, about 15.0% to about 20.0%, about 20.0% to about 25.0%, about 20.0% to about 30.0%, about 20.0% to about 35.0%, about 20.0% to about 40%, about 30.0% to about 35.0%, or about 30.0% to about 40.0%. In some embodiments, the binder may be present in the cathode composite in an amount of about 1.0%, 2.0%, 3.0%, 4.0%, 5.0%, 6.0%, 7.0%, 8.0%, 9.0%, 10.0%, 15.0%, 20.0%, 25.0%, 30.0%, 35.0%, or about 40.0% by weight of the separator layer. In an embodiment, the binder is present in the separator layer in an amount from about 1% to about 5% by weight of the separator layer.

### Combining Materials

When combining one or more of the materials contained in the cathode composite, separator layer, or anode layer to make the corresponding electrochemical cell layer, various types of mixing processes and equipment may be used. Equipment such as a mixer mill, a cryomill, a high energy ball mill, a planetary ball mill, and a drum mill may be used to combine each material included in each of the cathode composite, the separator layer, and the anode layer. The combining may be accomplished with or without the use of a solvent. The combining may include mixing, milling, or a combination thereof.

When one or more solvents is used during the mixing process, a slurry may be formed. This slurry may be a separator slurry containing one or more solvents, one or more solid electrolytes, and one or more binders. The slurry may be an anode slurry containing one or more solvents, one or more anode active materials, one or more binders, optionally one or more solid electrolytes, and optionally one or more conductive additives. The slurry may also be a cathode slurry containing one ore more solvents, one or more cathode active materials, one or more solid electrolytes, one or more conductive additives, and one or more binders.

The solvent(s) used in the slurry may comprise a hydrocarbon-based solvent, alone or in combination with one or more other solvents (e.g., an ester solvent, ether solvents, or nitrile solvents). The hydrocarbon solvent may include xylene, toluene, benzene, hexane, heptane, octane, nonane, decane, isoparaffins, or other hydrocarbon solvents known in the art and combinations thereof.

When mixing the slurry, high shear mixers and overhead mixers may also be utilized. These high speed or overhead mixers may be used to combine wet and dry ingredients. These mixers may be equipped with various blades which not only disperse the components but also reduce the particle size of the components.

Various types of bead milling equipment that may be used for combining the materials are known in the art such as continuous bead milling equipment or a batch bead milling equipment. The bead milling equipment may include wet bead milling equipment or dry bead milling equipment. In these cases, the beads are utilized to reduce the particle size of the materials to a desired particle size, such as less than 10 microns.

The combining may be conducted at a temperature from about 0° C. to about 90° C., such as about 0° C. to about 30° C., about 0° C. to about 60° C., about 30° C. to about 60° C., about 30° C. to about 90° C., or about 60° C. to about 90° C. The combining is typically conducted under ambient pressure and may also be conducted under an inert atmosphere, for example under nitrogen, argon, or helium.

The duration of this process may vary depending on the amounts and types of the component. In general, the duration of this process may range from about 1 minute to about 12 hours. In various embodiments, the duration of this step may range from about 1 minute to about 10 hours, from about 5 minutes to about 8 hours, or from about 10 minutes to about 5 hours.

When the combining is completed, the slurry may be coated onto a surface. The surface may be a current collector made of at least one conductive material such as aluminum, copper, nickel, stainless steel, or carbon.

The coating may be accomplished by pouring the slurry onto the surface via gravity or by pumping the slurry onto the surface. The process may take place in ambient conditions, or may take place in an inert atmosphere such as nitrogen or argon. In some embodiments, the process may be conducted in an atmosphere comprising air and moisture. In other embodiments, the process may be conducted in an atmosphere comprising air and substantially no moisture (i.e., less than 1% humidity).

The slurry may be coated onto the surface at ambient temperature and pressure. In some aspects, the slurry may be coated onto the surface at a temperature up to the boiling point of the solvent system used in the slurry, or the slurry may be coated at cooler temperatures to limit vaporization of the solvent.

Once the slurry has been coated on the surface, the solvent(s) may be removed by drying. The drying may occur at a temperature from about 15° C. to about 300° C. For example, the drying may occur at a temperature from about 15° C. to about 30° C., about 15° C. to about 50° C., about 15° C. to about 100° C., about 15° C. to about 150° C., about 15° C. to about 200° C., about 15° C. to about 250° C., about 15° C. to about 300° C., about 30° C. to about 300° C., about 50° C. to about 300° C., about 100° C. to about 300° C., about 150° C. to about 300° C., about 200° C. to about 300° C., or about 250° C. to about 300° C. In some embodiments, the drying may occur at a temperature of about 15° C., 20° C., 25° C., 30° C., 35° C., 40° C., 45° C., 50° C., 60° C., 70° C., 80° C., 90° C., 100° C., 125° C., 150° C., 175° C., 200° C., 225° C., 250° C., 275° C., or about 300° C. In some embodiments, the drying occurs at a temperature from about 50° C. to about 160° C. In some embodiments, the drying occurs at a temperature of 100° C. or less, 90° C. or less, 80° C. or less, 70° C. or less, or 60° C. or less.

After the drying step is completed, a dried composite is formed where the amount of solvent left in the dried composition may range from 0.01% to 0% by weight of the dried composition.

The dried composite may be compressed or densified using densification processes known to those having ordinary skill in the art, such as calendaring, linear densification, compaction, or compression. In preferred embodiments, the densifying may be accomplished via calendaring.

The dried composition may have a density after densification from about 50% to about 99% of the theoretical density of the dried composition. The theoretical density is defined as the maximum density of the composition that could be achieved assuming there are no voids or contaminants. The density may be from about 50% to about 60%, about 50% to about 70%, about 50% to about 80%, about 50% to about 90%, about 50% to about 95%, about 50% to about 99%, about 60% to about 99%, about 70% to about 99%, about 80% to about 99%, about 90% to about 99%, or about 95% to about 99% of the theoretical density of the dried composition.

The dried composition may have a porosity from about 1% to about 70%. For example, the dried composition may have a porosity from about 1% to about 10%, about 1% to about 20%, about 1% to about 30%, about 1% to about 40%, about 1% to about 50%, about 1% to about 60%, about 1% to about 70%, about 10% to about 70%, about 20% to about 70%, about 30% to about 70%, about 40% to about 70%, about 50% to about 70%, or about 60% to about 70%. The porosity of the dried composition may be measured through techniques known in the art, such as through SEM imaging, TEM imaging, FIB-SEM imaging, confocal microscopy, gas adsorption, mercury porosimetry, helium pycnometry, or other methods known in the art.

### Definitions

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

The term “about” will be understood by persons of ordinary skill in the art and will vary to some extent on the context in which it is used. As used herein when referring to a measurable value such as an amount, a temporal duration, and the like, the term “about” is meant to encompass variations of +10%, including+5%, +1%, and +0.1% from the specified value, as such variations are appropriate to perform the disclosed methods.

In this disclosure, “comprises,” “comprising,” “containing,” and “having” and the like may have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open-ended term, like “comprising” or “including,” it is understood that direct support should be afforded also to “consisting essentially of” language as well as “consisting of” language as if stated explicitly and vice versa.

### EXAMPLES

### Example 1

FeS₂, TiS₂, S, and Li₂S were mixed at a ratio of approximately 70:8:13.5:8.5 and xylenes were added as a solvent. This mixture was milled for 20 hours at 400 rpm, which formed a wet composite. The wet composite was then dried at a temperature of 150° C. for 2 hours under vacuum conditions to form a cathode composite in the form of a powder.

The composite powder was then mixed with xylenes, a SEBS binder, an Argyrodite solid electrolyte material with a formula Li₆PS₅Cl, and conductive additives. The weight percentages of the materials on a dry basis (i.e., not including the solvents) were about 44% transition metal sulfides, about 12% non-transition metal sulfur-containing materials, about 1% conductive additives, about 40% electrolyte, and remainder binder. This mixture was milled at 400 rpm for 2 hours to form a cathode slurry. This slurry was then cast onto an aluminum foil and dried under vacuum conditions until the solvents were removed to form the Cathode layer.

### Example 2

The cathode composite and the cathode layer of Example 2 were formed in the same manner as in Example 1 except the cathode composite was changed such that, on a dry basis, the composition was about 31 wt % FeS₂, about 2.5 wt % MoS₂, about 3 wt % TiS₂, about 19.5 wt % of the other non-transition metal sulfur-containing materials including elemental sulfur and lithium sulfide, about 4% conductive additive, about 37 wt % Argyrodite electrolyte, and the remainer SEBS binder.

### Example 3

The cathode composite and the cathode layer of Example 3 were formed in the same manner as in Example 2, except the cathode composite was changed such that the amount of MoS₂ in the cathode composite was 1.1 wt %.

### Example 4

The cathode composite and the cathode layer of Example 4 were formed in the same manner as in Example 2, except the cathode composite was changed such that the amount of MoS₂ in the cathode composite was 0.9 wt %.

### Example 5

The cathode composite and the cathode layer of Example 3 were formed in the same manner as in Example 2, except the cathode composite was changed such that the amount of MoS₂ in the cathode composite was 0.6 wt %.

### Assembling the Cell

An electrochemical cell was constructed using an anode layer made of Lithium Magnesium alloy, a separator layer comprising a Li₆PS₅Cl Argyrodite solid electrolyte material and a SEBS binder, and a cathode layer from each of Examples 1-5. The cell was assembled by placing the separator layer between the cathode layer and the anode layer to form a cell stack and compressing this stack to form an electrochemical cell.

### Cycling of the Electrochemical Cells

The electrochemical cells made using the cathode layers form Examples 1-5 were placed in an oven and held at a temperature of 45° C. during cycling. The voltage window of cell cycling was such that the lower cutoff voltage was 1 V and the upper cutoff voltage was 3.6 V. The cells were cycled at a rate of C/10.

### Experimental Results

TABLE 1

| | Cycle Number | 1 | 2 | 3 | 4 |
|---|---|---|---|---|---|
| Example 1 | Discharge Capacity (mAh/g) | 240 | 427 | 458 | 467 |
| Example 2 | Discharge Capacity (mAh/g) | 434 | 566 | 578 | 586 |
| Example 3 | Discharge Capacity (mAh/g) | 435 | 582 | 609 | 620 |
| Example 4 | Discharge Capacity (mAh/g) | 502 | 698 | 706 | 706 |
| Example 5 | Discharge Capacity (mAh/g) | 430 | 547 | 555 | 559 |

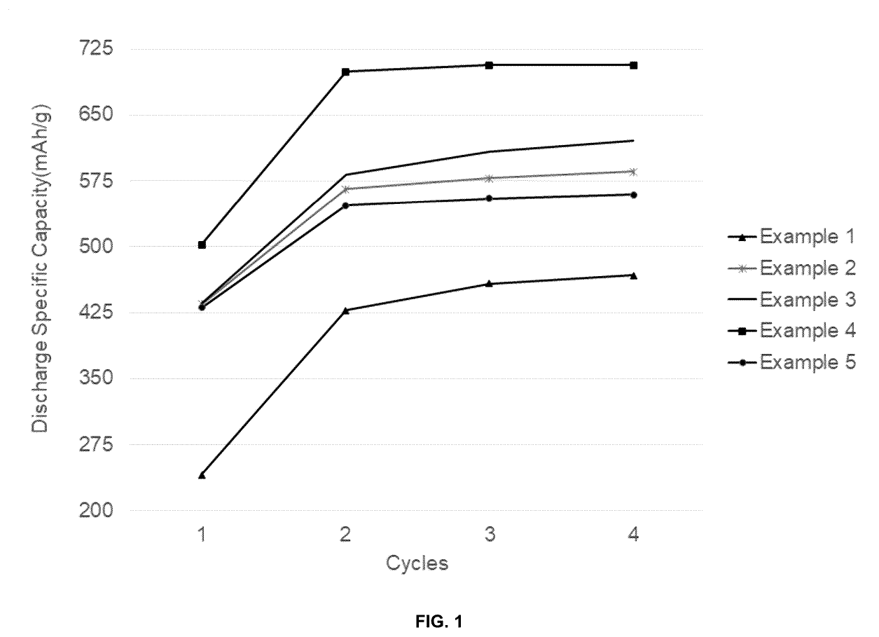

As shown in FIG. 1 and exemplified by the cycling data in Table 1, by incorporating Mo₂S into the cathode composite of a solid state electrochemical cell, the capacity of that cell was increased. Specifically, when MoS₂ was incorporated into the cathode in the amount of 0.6 wt %, the capacity on cycle one increased from 240 mAh/g to 430 mAh/g, or an increase of about 80%, as shown by comparing Example 1 to Example 5. Even at later cycles, the capacity of the cell was increased from 467 mAh/g to 586 mAh/g or an increase of about 20%.

When the amount of MoS₂ in the cathode layer was increased to 0.9 wt % as in Example 4, the discharge capacity was significantly increased. Comparing the data between Example 5 and Example 4, specifically the data for cycle #4, the capacity was further increased by 26%.

Surprisingly, when the amount of MoS₂ was increased above 1%, the discharge capacity dropped. Specifically, increasing the Mo₂S content in the cathode by just 0.2%, or from 0.9 wt % to 1.1 wt %, caused a 13% drop in discharge capacity. A further drop was seen when the MoS₂ content increased from 1.1 wt % to 2.5 wt %, as shown in Example 3 vs Example 2.

What is claimed:

1. A cathode composite comprising:
a transition metal sulfide; and
a molybdenum sulfide material,
wherein the molybdenum sulfide material is present in the cathode composite in an amount of about 1% or less by weight of the cathode composite.

2. The cathode composite of claim 1, wherein the transition metal sulfide includes FeS, FeS₂, LiFeS₂, Li₂FeS₂, Li₃FeS₂, TiS₂, LiTiS₂, Li_{1.5}TiS₂, Li₂TiS₃, or any combination thereof.

3. The cathode composite of claim 1, wherein the transition metal sulfide is present in the cathode composite in an amount from about 1% to about 90% by weight of the cathode composite.

4. The cathode composite of claim 1, wherein the molybdenum sulfide material comprises MoS₂MoS₃, LiMoS₂, Li₂MoS₂, Li₃MoS₂, or any combination thereof.

5. The cathode composite of claim 1, wherein the molybdenum sulfide material is present in the cathode composite in an amount from about 0.05% to about 1% by weight of the cathode composite.

6. The cathode composite of claim 1, wherein the molybdenum sulfide material is present in the cathode composite in an amount from about 0.05% to about 0.8% by weight of the cathode composite.

7. The cathode composite of claim 1, wherein the molybdenum sulfide material is present in the cathode composite in an amount from about 0.05% to about 0.5% by weight of the cathode composite.

8. The cathode composite of claim 1, further comprising a conductive additive, wherein the conductive additive is present in the cathode composite in an amount from about 1% to about 20% by weight of the cathode composite.

9. The cathode composite of claim 1, further comprising a solid electrolyte material, wherein the solid electrolyte material is present in the cathode composite in an amount from about 0% to about 60% by weight of the cathode composite.

10. The cathode composite of claim 1, further comprising a binder, wherein the binder is present in the cathode composite in an amount from about 1% to about 40% by weight of the cathode composite.

11. A cathode composite comprising a molybdenum sulfide material, wherein the molybdenum sulfide material is present in the cathode composite in an amount of about 1% or less by weight of the cathode composite

12. A solid-state electrochemical cell comprising an anode layer, a separator layer, and a cathode layer, the cathode layer comprising a cathode composite disposed on a current collector, wherein the cathode composite comprises a molybdenum sulfide material, and wherein the molybdenum sulfide material is present in the cathode composite in an amount greater than 0% to less than about 1% by weight of the cathode composite.

13. The solid-state electrochemical cell of claim 12, wherein the cathode composite further comprises a transition metal sulfide.

14. The solid-state electrochemical cell of claim 13, wherein the transition metal sulfide is one or more of FeS, FeS₂, LiFeS₂, Li₂FeS₂, and Li₃FeS₂, or a combination thereof.

15. The solid-state electrochemical cell of claim 14, wherein the transition metal sulfide material further comprises TiS₂, LiTiS₂, Li_{1.5}TiS₂, Li₂TiS₃, or any combination thereof.

16. The solid-state electrochemical cell of claim 12, wherein the molybdenum sulfide material comprises a non-lithiated Molybdenum sulfide material.

17. The solid-state electrochemical cell of claim 12, wherein the molybdenum sulfide material comprises a lithiated Molybdenum sulfide material.

18. The solid-state electrochemical cell of claim 12, wherein the molybdenum sulfide material comprises MoS_{z}, wherein 2≤z≤3.

19. The solid-state electrochemical cell of claim 12, wherein the molybdenum sulfide material comprises LiₓMoS_{y}, wherein 0<x≤4 and 1≤y≤4.

20. The solid-state electrochemical cell of claim 12, wherein the molybdenum sulfide material comprises MoS_{z} and LiₓMoS_{y}, wherein 2≤z≤3, 0<x≤4 and 1≤y≤4.

21. The solid-state electrochemical cell of claim 20, wherein the weight ratio of the MoS_{z} to the LiₓMoS_{y} material is from 1:99 to 99:1.

22. The solid-state electrochemical cell of claim 12, wherein the Molybdenum sulfide comprises MoS₂, MoS₃, LiMoS₂, Li₂MoS₂, Li₃MoS₂, or any combination thereof.

23. The solid-state electrochemical cell of claim 12, wherein the cathode composite further comprises a conductive additive.

24. The solid-state electrochemical cell of claim 12, wherein the cathode composite further comprises a solid electrolyte material.

25. The solid-state electrochemical cell of claim 12, wherein the cathode composite further comprises a binder.
